(19) United States
(12) Patent Application Publication
(10) Pub. No.: US 2010/0132741 A1
(43) Pub. Date: Jun. 3, 2010

(54) Detergent Composition

(75) Inventors: Stefan Frey, Ludwigshafen (DE); Laurence Geret, Pulheim-Stommeln (DE); Judith Preuschen, Ludwigshafen (DE); Ralf Wiedemann, Mira (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/519,670

(22) PCT Filed: Dec. 21, 2007
(86) PCT No.: PCT/GB2007/004955

§ 371 Date: Feb. 4, 2010

(30) Foreign Application Priority Data
Dec. 21, 2006 (GB) 0625586.3

(51) Int. Cl. C11D 3/20; B08B 7/04

(52) U.S. Cl. 134/18; 510/227

(57) ABSTRACT

The present invention relates to a detergent composition comprising at least one surfactant, at least one biodegradable builder and, at least one source of metal ions, wherein the metal ions are selected from zinc; tin; magnesium; calcium; strontium; titanium; zirconium; manganese; and/or bismuth. The composition is especially suitable for use as a dishwasher detergent composition. The present invention also relates to methods for using such a composition as well as methods of washing dishes with the composition.

### FIELD OF INVENTION

The invention relates to a detergent composition for machine dishwashing, in particular to a detergent composition for machine dishwashing which provides good cleaning performance, acceptable build-up properties and glass corrosion protection benefits.

### BACKGROUND

In recent years there has been an ever increasing trend towards safer and environmentally friendly detergent compositions. This has led to development of alternative complexing agents (builders), which are used instead of predominantly phosphorous based builders. Phosphate builders can be connected with eutrophication issues.

On the other hand phosphates can bind calcium and magnesium ions, and also act as an alkalinity source for the detergent, thus, they are used to buffer the wash liquor in a dishwasher above pH 9 together with other chemicals such as disilicate, metasilicates and soda.

Phosphates are also able to disperse existing calcium carbonate in the wash liquor to prevent spotting on glasses.

The use of more environmentally friendly biodegradable complexing agents, such as β-alaninediacetic acid (β-ADA) and isoserinediacetic acid (ISDA) in detergents is disclosed in DE-A-3,829,847 and DE-A-4,036,995. However, the materials are very expensive.

One other environmentally friendly builder that has been used in dishwasher detergent formulations are salts of citric acid. This has the advantage that these salts are biodegradable, and environmentally friendly.

Indeed the dishwasher detergents proposed to date which use environmentally friendly complexing agents have the disadvantage that they are only effective at a relatively high pH. In order to provide this high pH, pH adjusting agents usually need to be added to the composition. These pH adjusting agents can act as additional buffering system, but cause side problems of filming and spotting on dishes. Repeated wash cycles can also lead to glass and machine corrosion, and lime-scale build-up, even on dishes.

It is an object of the invention to address at least one of the above problems and/or to offer detergent compositions with usage and/or environmental benefits.

### STATEMENT OF INVENTION

According to a first aspect of the present invention therefore, there is provided a detergent composition comprising:

(i) at least one surfactant,

(ii) at least one biodegradable builder and,

(iii) at least one source of metal ions, wherein the metal ions are selected from zinc; tin; magnesium; calcium; strontium; titanium; zirconium; manganese; and/or bismuth.

According to a second aspect of the invention there is provided a method for washing kitchenware in an automatic dishwashing machine wherein a detergent composition of the first aspect is added to the automatic dishwashing machine.

According to a third aspect there is provided a method for washing kitchenware in an automatic dishwashing machine wherein a detergent composition according to the first aspect of the invention is added to the automatic dishwashing machine.

Compositions according to the present invention are particularly suitable for the protection of glassware in an automatic dishwashing process from detrimental effects caused by exposure of the glassware to the alkaline wash liquor and at the same time they provide good cleaning performance. Indeed, compositions according to the present invention may be used to address potential problems which can be caused by exposure of glassware to a source of detrimental substances such as aluminium in a dishwasher liquor.

Surprisingly, it has been found that compositions according to the present invention may have the ability to substantially remove food residues combined with an ability to potentially prevent/remove the build-up of precipitates (scale deposition) formed by calcium and/or magnesium ions; such as limescale.

Without being bound to theory it is believed that the biodegradable builder reduces the activity of the metal in corrosion prevention in low wash temperatures whereas at elevated wash temperatures, conditions in which glass corrosion is more severe, the metal in compositions according to the invention is highly efficient.

In the present invention it is understood that the term glassware includes items made of glass (such as drinking glasses and plates) which may be decorated (such as with a glaze and/or with etching/glass addition). The term glassware is also understood to include other items of houseware, which may comprise a material other than glass (such as a ceramic) but which have a glass/glaze coating or decoration (such as a glazed ceramic plate).

The term “hard water” as used ‘herein is used to designate water with a hardness >10° German hardness.

Unless otherwise stated all amounts are given as percentages by weight based upon the total weight of the composition.

### DETAILED DESCRIPTION

The invention will now be described in further detail.

Surfactant

The compositions of the invention comprise at least one surfactant.

Preferably the surfactant is selected from anionic, non-ionic, cationic, amphoteric or zwitterionic surface active agents or mixtures thereof, most preferably non-ionic, cationic and amphoteric surfactants. Many such surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred.

One possible class of nonionic surfactants are ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles particularly preferred at least 16 and still more preferred at least 20 moles of ethylene oxide per mole of alcohol.

According, to one preferred embodiment of the invention, the non-ionic surfactants additionally comprise propylene oxide (PO) units in the molecule. Preferably these PO units constitute up to 25% by weight, preferably up to 20% by weight and still more preferably up to 15% by weight of the overall molecular weight of the non-ionic surfactant. Particularly preferred surfactants are ethoxylated mono-hydroxy alkanols or alkylphenols, which additionally comprises polyoxyethylene-polyoxypropylene block copolymer units. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH(CH₃)O]_{X}[CH₂O]_{Y}[CH₂CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, alyphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where group with 8 to 18 carbon atoms are particularly preferred. For the group R³H, methyl or ethyl are particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different nonionic surfactants is suitable in the context of the present invention for instances mixtures of alkoxylated alcohols and hydroxy group containing alkoxylated alcohols.

Other suitable surfactants are disclosed in WO 95/01416, to the contents of which express reference is hereby made.

Builder

Preferably the biodegradable builder is present in the composition in an amount of at least 35 wt %, preferably at least 40 wt %, more preferably at least 45 wt %, and most preferably at least 50 wt %. Preferably the biodegradable builder is present in the composition in an amount of up to 90 wt %, preferably up to 80 wt %, more preferably up to 75 wt %, and most preferably up to 70 wt %. It is most preferred that he biodegradable builder is present in an amount of from 30-70 wt %.

Preferably the biodegradable builder comprises a monomeric polycarboxylic acid salt or a hydroxycarboxylic acids salt. The biodegradable builder system preferably comprises a salt of a polycarboxylic acid or a hydroxypolycarboxylic acid containing 2-8 carboxyl groups, more preferably 2-4 carboxyl groups.

Preferred salts of the abovementioned compounds are the ammonium and/or alkaline metal salts, i.e. the lithium, sodium, and potassium salts, and particularly preferred salts are the sodium salts.

Preferably the biodegradable builder is a polycarboxylate. Suitable polycarboxylic acids are acyclic, alicyclic, heterocyclic and aromatic carboxylic acids, in which case they contain at least two carboxyl groups which are in each case separated from one another by, preferably, no more than two carbon atoms. It is preferred that the polycarboxylate comprises two carboxyl groups including, for example, water-soluble salts of succinic acid, malonic acid, (ethylenedioxy)diacetic acid, maleic acid, diglycolic acid, tartaric acid, tartronic acid and fumaric acid. Polycarboxylates which contain three carboxyl groups include, for example, water-soluble citrate. Most preferred are salts of hydroxycarboxylic acid, for example, citric acid.

According to one aspect of the invention it is especially preferred that the biodegradable builder comprises citric acid and/or citrate, especially citrate.

The biodegradable builders may comprise an amino acid based compound or a succinate based compound. Preferred examples of amino acid based compounds include MGDA (methyl-glycine-diacetic acid, and salts thereof) and glutamic-N,N-diacetic acid. Preferred succinate compounds are described in U.S. Pat. No. 5,977,053 and have the formula

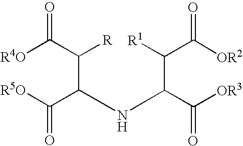

in which

R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁸, R⁹, independently of one another, denoting hydrogen, alkyl radicals having 1 to 12 C atoms or hydroxyl-substituted alkyl radicals having 2 to 3 C atoms. A preferred example is tetrasodium imminosuccinate.

Compositions of the invention containing MGDA have been found to be particularly well suited to being press-formed into solid bodies such as tablets.

Preferably at least two biodegradable builders (or cobuilders) are present in the composition. Preferred builders include homopolymers and copolymers of polycarboxylic acids and their partially or completely neutralized salts, additional monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts.

Poly-aspartic acid shows excellent rinse properties in phosphorus-free compositions.

Builders which are organic are preferred.

HOOC—CH(NH₂)—CH₂—COOH

containing monomer units of the formula

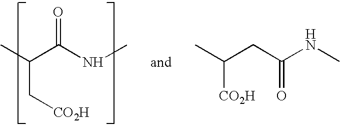

Another suitable polycarboxylic acid is the homopolymer of acrylic acid.

Other suitable builders are disclosed in WO 95/01416, to the contents of which express reference is hereby made.

Particularly preferred is at least one builder comprising a salt of a hydroxycarboxylic acid or of the mixture of a hydroxycarboxylic acid and the salt of a hydroxycarboxylic acid.

However, although phosphorus-containing secondary builders may be present in this invention, preferred compositions are substantially free of phosphorous-containing compounds. By this is meant that the compositions do not comprise more than 5% wt phosphorous containing compounds preferably not more than 1% wt. phosphorus-containing compound(s).

Metal Ion Source

The compositions of the present invention further comprise at least one source of wherein the metal ions are selected from zinc; tin; magnesium; calcium; strontium; titanium; zirconium; manganese; and/or bismuth.

It is most preferred according to the present invention that the composition comprises two or more of the aforementioned sources of metal ions.

Preferably the sources of metal ions comprises at least one source of zinc ions and at least one source of bismuth ions. When present, the weight ratio of zinc ions to bismuth ions in the composition is preferably in the range of from 1:100 to 100:1. More preferably the weight ratio of zinc ions to bismuth ions is in the range of from 1:10 to 10:1, more preferably from 1:5 to 5:1 and most preferably about 1:1.

The amount of the metal ions obtained from the source of the metal ion(s) in the composition is preferably of from 0.001 to 1% wt, more preferably 0.01 to 0.5% wt. A suitable amount of the metal ion for use in a dishwasher cycle, may be from 1 to 1000 mg, and preferably from 1 to 500 mg, and more preferably from 1 to 200 mg, and most preferably 5 to 100 mg.

Most preferably the composition is configured such that, in use of the composition, zinc ions and bismuth ions are made available in the dishwasher washing liquor.

The at least one source of metal ions in the composition of the present invention may be provided in a metallic form of the metal(s), as a salt or as a compound. Such metallic form or forms may be solubilised to provide soluble ions of the metal(s). Where at least two metal ion sources are present, these sources may also comprise an admixture (such as an alloy) of metal ions. The alloy may contain further elements, such as other metal elements necessary to ensure stability/solubility of the alloy. Most preferably the salt(s)/compound(s) has an appreciable solubility in the washing liquor so that the effect of the at least one metal can be observed. However, a salt(s) of said at least one metal possessing a low solubility may also be used. In the latter case (as when a metallic form of one or more of the elements themselves is used) the amount of metal salt(s)/compound(s) disposed in the composition of the present invention may be increased accordingly to counter the low solubility of the low solubility salts.

Most preferably the salt(s)/compound(s) are configured such that in use, say in a dishwashing cycle, they are not aggressive/detrimental to the dishwasher/dishwasher contents. In the case where the salt(s)/compound(s) is ionic it is preferred that the salt(s)/compound(s) is free from chloride anions which are recognised to have a detrimental effect on dishwashers (more particularly on stainless steel dishwasher components/cutlery).

Preferred examples of soluble metal salts include compounds with anions such as nitrate, sulphate, halide (especially fluoride), carbonate and carboxylate (such as the anions from C₁-C₁₀ mono or multi carboxy function containing carboxylic acids, especially acetate and citrate).

Preferred examples of metal compounds having a lower solubility include the oxides of the metals.

An admixture of more than one compound may be used. Also a different compound of each metal may be used.

### Optional Aspects of the Invention

a) Polymer

It is preferred that the compositions of the invention comprise at least one polymer. According to one aspect it is preferred that the polymer is biodegradable. However, according to the invention in an alternative embodiment is sulfonated polymers are preferred for use.

Preferred examples of suitable sulphonated polymers include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkaline metal with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in the composition include sulphonated (co)polymers such as 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. It is especially preferred that the sulphonated polymer comprises 2-acrylamido-2-methyl-1-propanesulfonic acid. Suitable sulfonated polymers are also described in U.S. Pat. No. 5,308,532 and in WO 2005/090541.

Sulfonated polymers are used in detergency applications as polymers to disperse Ca-phosphate compounds and prevent their deposition. Surprisingly, we have found such polymers to give cleaning benefits in combination even with preferred phosphorus-free compositions of the present invention.

Where a polymer(s) is present, it is preferably present in the composition in an amount of at least 2 wt %, preferably at least 4 wt %, more preferably at least 6 wt %, and most preferably at least 8 wt %. Where a polymer(s) is present, it is preferably present in the composition in an amount of up to 40 wt %, preferably up to 25 wt %, more preferably up to 20 wt %, and most preferably up to 15 wt %. According to one embodiment the polymer is present in an amount of from 2 wt % to 40 wt %.

b) Bleach

A bleach component may be present in a composition of the invention.

When a bleach is present, it is preferably present in the composition in an amount of at least 1 wt %, more preferably at least 2 wt %, more preferably at least 4 wt %. When a bleach is present, it is preferably present in the composition in an amount of up to 30 wt %, more preferably up to 20 wt %, and most preferably up to 15 wt %. Amounts of 1% to 30% wt of bleach component are especially preferred.

Most preferably a bleach is selected from inorganic peroxy-compounds and organic peracids and the salts derived therefrom.

It is especially preferred according to the present invention that the detergent composition further comprises from 1 wt % to 30 wt % of a bleach component selected from inorganic peroxy-compounds and organic peracids and salts derived therefrom.

Examples of inorganic perhydrates are persulfates such as peroxymonopersulfate (KMPS), Perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life.

The preferred percarbonate is sodium percarbonate of the formula 2Na₂CO₃.3H₂O₂. A percarbonate, when present, is preferably used in a coated form, to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

Where bleach is present in a composition of the present invention, the composition may also comprise one or more bleach activators. These activators are preferably used in detergents for dishwashing cycles at temperatures in the range below 60° C. in order to achieve an adequate bleaching action. Particularly suitable examples are N- and O-acyl compounds, such as acylated amines, acylated glycolurils or acylated sugar compounds. Preference is given to pentaacetylglucose (PAG) and tetraacetylglycoluril (TAGU). Also favoured are ammonium nitrile compounds of formula 1 below:

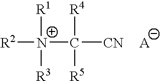

in which R¹, R², and R³ are the same of different and can be linear or branched C1-24 alkyl, C2-24 alkenyl, or c2-4-C1-4 alkyl groups, or substituted or unsubstituted benzyl; or wherein R¹ and R² together with the nitrogen atom from a ring structure. Other suitable bleach activators are, however, catalytically active metal complexes and, preferably, transition metal complexes. Other suitable bleach activators are disclosed in WO 95/01416 (various chemical classes) and in EP-A-1 209 221 (cyclic sugar ketones).

c) Enzymes

The composition preferably comprises one or more enzymes, preferably selected from protease, lipase, amylase, cellulase and peroxidase enzymes. Such enzymes are commercially available and sold, for example, under the registered trade marks Esperase, Alcalase and Savinase by Novo Industries A/S. Desirably the enzyme(s) is/are present in the composition in an amount of from 0.01 to 3 wt %, especially 0.01 to 2 wt % (active enzyme(s) present).

d) Alkalinity

The dishwasher detergent according to the invention preferably also comprises a source of alkalinity, to obtain the desired alkaline pH on dissolution. Typically the alkalinity may be any of the components which are basic; for example any salt of a strong base and a weak acid. It is especially preferred according to the present invention that the compositions comprise a suitable amount of carbonate or a source of carbonate. Typically the source of alkalinity will be present in an amount of from 1 to 30% wt, more preferably 5 to 15% wt.

In the case of alkaline compositions silicates may be suitable additives. Preferred silicates are sodium silicates such as sodium disilicate, sodium metasilicate and crystalline phyllosilicates.

Preferably the composition of the present invention yields an alkaline washing medium when contacted with water and preferably it is an alkaline dishwasher detergent composition. Thus, preferred embodiments of the invention are adapted to produce alkaline washing liquors. For the purposes of this specification alkaline is defined as pH 8 to pH 12, and more preferably from pH 8.5 to pH 11; when dissolved 1:100 (wt:wt, composition:water) in de-ionised water at 20° C., measured using a conventional pH meter.

e) Other Optional Ingredients

The detergent composition according to the present invention may further comprise one or more foam control agents. Suitable foam control agents for this purpose are all those used in this field, such as, for example, silicones and paraffin oil. Foam control agents are preferably present in amounts of less than 5% by weight of the total weight of the detergent.

The detergent composition according to the invention may also comprise a silver/copper corrosion inhibitor. This term encompasses agents which are intended to prevent or reduce the tarnishing of non-ferrous metals, in particular of silver and copper.

Suitable silver/copper corrosion inhibitors include organic and/or inorganic redox-active substances, for example benzotriazole derivatives. Such benzotriazole derivatives are compounds in which the available substitution sites on the aromatic ring are partially or completely substituted. Suitable substituents are linear or branch-chain C₁₋₂₀-alkyl groups and hydroxyl, thio, phenyl or halogen such as fluorine, chlorine, bromine and iodine. A preferred substituted benzotriazole is tolyltriazole.

Suitable bis-benzotriazoles derivatives are those in which the benzotriazole groups are each linked in the 6-position by a group X, where X may be a bond, a straight-chain alkylene group which is optionally substituted by one or more C₁₋₄-alkyl groups and preferably has 1-6 carbon atoms, a cycloalkyl radical having at least 5 carbon atoms, a carbonyl group, a sulfuryl group, an oxygen atom or a sulfur atom. The aromatic rings of the bis-benzotriazoles may be substituted as defined above for benzotriazole.

Suitable organic redox-active substances are, for example, ascorbic acid, indole, methionine, an N-mono-(C₁-C₄-alkyl)glycine, an N,N-di-(C₁-C₄-alkyl)glycine, 2-phenylglycine or a coupler and/or developer compound chosen from the group consisting of diaminopyridines, aminohydroxypyridines, dihydroxypyridines, heterocyclic hydrazones, aminohydroxypyrimidines, dihydroxypyrimidines, tetraaminopyrimidines, triaminohydroxypyrimidines, diaminodihydroxypyrimidines, dihydroxynaphthalenes, naphthols, pyrazolones, hydroxyquinolines, aminoquinolines, of primary aromatic amines which, in the ortho-, meta- or paraposition, have another hydroxyl or amino group which is free or substituted by C₁-C₄-alkyl or C₂-C₄-hydroxyalkyl groups, and of di- or trihydroxybenzenes.

Suitable inorganic redox-active substances are, for example, metal salts and/or metal complexes chosen from the group consisting of manganese, titanium, zirconium, hafnium, vanadium, cobalt and cerium salts and/or complexes, the metals being in one of the oxidation states II, III, IV, V or VI.

Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃.

Organic and inorganic redox-active substances which are suitable as silver/copper corrosion inhibitors are also mentioned in WO 94/26860 and WO 94/26859, to the contents of which reference is hereby made.

Suitable paraffin oils are predominantly branched aliphatic hydrocarbons having a number of carbon atoms in the range from 20 to 50. Preference is given to the paraffin oil chosen from predominantly branched-chain C₂₅₋₄₅ species having a ratio of cyclic to noncyclic hydrocarbons of from 1:10 to 2:1, preferably from 1:5 to 1:1.

If a silver/copper corrosion inhibitor is present in the detergent composition according to the invention, it is preferably present in an amount of from 0.01 to 5% by weight, particularly preferably in an amount of from 0.1 to 2% by weight, of the total weight.

Other customary additives are, for example, dyes and perfumes and optionally in the case of liquid products, preservatives, suitable examples of which are compounds based on isothiazolinone.

f) Form of the Composition

The detergent compositions of the invention may be in any suitable form such as a liquid, gel, powder or tablet formulation. Where the composition is a liquid/gel generally the metal will be present in solution within the liquid/gel. However, it is also contemplated to have the metal present in the liquid/gel in the form of an insoluble salt/compound so that the metal may comprise a suspended particle (e.g. such as a “speckle” typically found in these formulations). According to one embodiment it is especially preferred that the composition is in the form of a tablet as it has been found that the compositions of the invention are very suitable for forming a tablet.

Preferably the composition has a solids content of more than 25% wt, and preferably more than 50% wt.

The composition of the present invention may, for example, be in the form of a tablet, rod, ball or lozenge. The composition may be provided in a particulate form, loose or pressed to shape or may be formed by injection moulding or by casting or by extrusion. The composition may be encased in a water soluble wrapping, for, example of PVOH or a cellulosic material. The composition may be a gel.

Preferably the compositions according to the invention are for washing dishes in the presence of hard water, for example hard water with a hardness >10° German hardness.

According to the third aspect of the present invention it is preferred that the water provided to the automatic dishwashing machine has a hardness of at least 10° German hardness.

### Description of an Embodiment

The composition is described with reference to the following non-limiting Examples.

### Examples

Formulation 1
Automatic Dishwashing Tablet

| Component | Wt % |
|---|---|
| Sodium Tripolyphosphate STPP | 60.0 |
| Sodium Bicarbonate | 7.0 |
| Sodium Percarbonate | 13.4 |
| TAED | 5.8 |
| Citric Acid | 3.0 |
| PEG 1500 | 2.8 |
| Surfactant (Fatty Alcohol Polyglcolether) | 3.9 |
| Protease (Properase ™) | 1.8 |
| Amylase (Duramyl ™) | 1.0 |
| Polycarboxylate Sodium Salt | 0.5 |
| Phosphonic Acid Sodium Salt | 0.2 |
| BTA | 0.2 |
| Glycerol | 0.2 |
| Zinc Oxide | 0.1 |
| Perfume | 0.1 |
| Total | 100% |

The formulation has a pH of 10.4

Formulation 2
Automatic Dishwashing Tablet

| Component | Wt % |
|---|---|
| Sodium Citrate | 53.8 |
| Sodium Percarbonate | 15.0 |
| Sodium Carbonate | 8.0 |
| TAED | 5.0 |
| Sulfonated Polycarboxylate Sodium Salt | 5.0 |
| PEG 1500 | 4.9 |
| PEG 6000 | 1.2 |
| Surfactant (Fatty Alcohol Polyglcolether) | 3.1 |
| Protease (Properase ™) | 1.6 |
| Amylase (Duramyl ™) | 1.0 |
| Phosphonic Acid Sodium Salt | 0.5 |
| BTA | 0.3 |
| Sodium Bicarbonate | 0.2 |
| Glycerol | 0.1 |
| Zinc Sulfate | 0.1 |
| Perfume | 0.1 |
| Total | 100% |

The formulation has a pH of 10.3.

### Application Examples

The cleaning ability of the formulations was tested in a Miele 651 dishwashing machine using a 50° C. cycle Normal, according to the method IKW. In each case 20 g of the composition was added to the dosing chamber of the dishwasher. The water hardness was 21° gH. The results (given in Table 1) are expressed on a scale of 1-10 (1 being worst and 10 being best).

These results show that a citrate based formulation according to the invention (2) provides excellent cleaning results at alkaline pH which is in line with a phosphate based formulation which is not according to the invention (1).

To increase the performance of the bleach and the protease, the concentration of those components can be increased.

TABLE 1
Cleaning Performance

| | Formulation 1 | Formulation 2 |
|---|---|---|
| Test condition | Miele G 651 SC | Miele G 651 SC |
| | 50° C. normal | 50° C. normal |
| | 21° GH | 21° GH |
| Bleachable | 3.2 | 3.4 |
| Stain - Tea | | |
| Starch - | 7.2 | 8.0 |
| dried on oat | | |
| flakes | | |
| Starch - | 9.1 | 8.0 |
| dried on | | |
| starch mix | | |
| Protein - | 9.0 | 9.0 |
| dried on | | |
| minced meat | | |
| Protein - | 4.8 | 4.9 |
| dried on egg | | |
| yolk | | |
| Protein - | 6.2 | 6.2 |
| dried on egg | | |
| yolk/milk | | |
| Burnt-on - | 6.3 | 6.1 |
| milk | | |

Build-up Performance after 10, 20 and 30 cycle

| | Formulation 2 |
|---|---|
| Test condition | Miele G 651 SC |
| | 21° GH |
| Glasses | |
| 30 cycles | 1.1 |
| 20 cycles | 1.4 |
| 10 cycles | 1.7 |
| Plastic Plates | |
| 30 cycles | 2.0 |
| 20 cycles | 2.0 |
| 10 cycles | 2.5 |
| Glass Plates | |
| 30 cycles | 1.0 |
| 20 cycles | 1.5 |
| 10 cycles | 1.5 |
| Stainless Steel Cutlery | |
| 30 cycles | 2.0 |
| 20 cycles | 2.0 |
| 10 cycles | 2.5 |

The results show that a citrate based formulation according to the invention (2) provides excellent scale prevention properties which is in line with a phosphate based formulation which is not according to the invention (1) (results not shown).

Test Method

In the Examples test glasses were washed 50 to 100 times in a test dishwasher (Bosch SGS 3322, special modified according to EN 12875-1.

Dosage: 20g composition of the formulations 1 described above. Automatic dosing at the beginning of the cleaning cycle.

Cleaning program 65° C. (both the cleaning and the rinse cycle were operated at 65° C.)

Water consumption per cycle: 20 litres.

There was no soiling on the dishes tested.

The test report comprised the following types of dishes:

Clear Glasses
Clear Glasses:
   Asa Gray (IKEA),
   Longchamp+Elegance (Arc International),
   Julia Paola (Nachtmann),
   Fiori (Böckling/Royal Leerdam)
   Wasserglas (Stölze Oberglas)
   Mondial (Schott-Zwiesel)
   Dune (Leonardo)

Decorated Dishes
Glasses with Decoration:
   Kinderbecher Flirt (Ritzenhoff & Breker),
   Skyline Aqua (Leonardo)
Glass-plates with decoration:
   Rubis (Arc International),
Ceramics with decoration:
   Flirt cup, Flirt saucer (R&B)

Visible changes to the clear glass surface were evaluated in natural light or in a special light box. The dimensions of the light box were 70 cm×40 cm×65 cm (1×b×h) and the inside of the box was painted matt black. The box was lit from above with an L 20 w/25 S (60 cm long) Osram lamp, which was covered in front with a screen. Shelves were disposed in the box on which the glasses were placed for evaluation. The box was open at the front.

The glass corrosion was evaluated using the following criteria; glass clouding (GC), line corrosion (CL) and decoration damage (DS). The parameters glass clouding and line corrosion were used for the non-decorated glasses and the parameter decoration damage for the decorated glasses. For each parameter an average score of all test items was given in accordance with the table below.

| Evaluation | Damage Impact |
|---|---|
| 5 | no surface modifications |
| 4 | minor surface modifications, hardly visible |
| 3 | visible surface modifications |
| 2 | strong surface modifications |
| 1 | very strong surface modifications, clearly visible |

Cycles

| | 50 | 100 |
|---|---|---|
| Glass Clouding | | |
| Formulation 1 | 2.4 | 2.1 |
| Formulation 2 | 2.7 | 2.6 |
| Line Corrosion | | |
| Formulation 1 | 3.1 | 2.2 |
| Formulation 2 | 3.4 | 3.3 |
| Onglaze Decor Damages | | |
| Formulation 1 | 3.0 | 2.4 |
| Formulation 1 | 3.8 | 3.4 |

Result:

Formulation 2 based on a biodegradable builder shows an excellent corrosion profile, especially on glass surfaces. The damage of decorated surfaces is also minimised.

1. A detergent composition comprising:
(i) at least one surfactant,
(ii) at least one biodegradable builder and,
(iii) at least one source of metal ions, wherein the metal ions are selected from zinc; tin; magnesium; calcium; strontium; titanium; zirconium; manganese; and/or bismuth.

2. A detergent composition according claim 1, wherein the at least one surfactant is chosen from nonionic surfactants, cationic surfactants and amphoteric surfactants and mixtures thereof.

3. A detergent composition according to claim 1, wherein the biodegradable builder is present in an amount of from 30-70 wt %.

4. A detergent composition according to claim 1, wherein the biodegradable builder comprises a monomeric polycarboxylic acid salt or a hydroxycarboxylic acid salt.

5. A detergent composition according to claim 4, wherein the polycarboxylic acid or hydroxypolycarboxylic acid has 2-8 carboxyl groups.

6. A detergent composition according to claim 4, wherein the biodegradable builder comprises citric acid and/or citrate.

7. A detergent composition according to claim 4, wherein the salt(s) are selected from ammonium and/or alkaline metal salts.

8. A detergent composition according to claim 1, comprising two or more of the sources of metal ions.

9. A detergent composition according to claim 8, wherein the sources of metal ions comprises at least one source of zinc ions and at least one source of bismuth ions.

10. A detergent composition according to claim 9, wherein the weight ratio of zinc ions to bismuth ions is in the range from 1:100 to 100:1.

11. A detergent composition according to claim 1, wherein the metal ions obtained from the source of metal ions are present in the composition in an amount of from 0.001 to 1% wt based on the total weight of the composition.

12. A detergent composition according to claim 11, wherein the metal ions obtained from the source of metal ions are present in the composition in an amount of from 0.01 to 0.5% wt.

13. A detergent composition according to claim 1, wherein the at least one source of metal ions is present in metallic form, as a compound or as a salt.

14. A detergent composition according to claim 1, wherein the composition further comprises at least one polymer.

15. A detergent composition according to claim 14, wherein the at least one polymer is biodegradable.

16. A detergent composition according to claim 14, wherein the polymer comprises a sulfonated polymer or copolymer which includes, as a or the monomer unit, a compound of formula;
CH₂═CR¹—CR²R³—O—C₄H₃R⁴—SO₃X
wherein R¹, R², R³, R⁴ are independently 1 to 6 carbon alkyl or hydrogen, and X is hydrogen or alkaline metal.

17. A detergent composition according to claim 16, wherein the sulfonated polymer, includes, as a or the monomer unit, 2-acrylamido-2-methyl-1-propanesulfonic acid.

18. A detergent composition according to claim 14, wherein the polymer is present in an amount of from 2 wt % to 40 wt %.

19. A detergent composition according to claim 1, wherein the composition further comprises 0.01 to 3 wt % of one or more enzymes.

20. A detergent composition according to claim 1, wherein the composition is substantially free of phosphorous-containing compounds.

21. A detergent composition according to claim 1, wherein the composition further comprises from 1 wt % to 30 wt % of a bleach component selected from inorganic peroxy-compounds and organic peracids and salts derived therefrom.

22. A detergent composition according to claim 21, which further comprises a carbonate or a source of carbonate.

23. A detergent composition according to claim 22, which yields an alkaline washing medium when contacted with water.

24. (canceled)

25. A method for washing kitchenware in an automatic dishwashing machine wherein a detergent composition according to claim 1 is added to the automatic dishwashing machine.

26. A method according to claim 25, wherein the water provided to the automatic dishwashing machine has a hardness of at least 10° German hardness.
